(19) United States
(12) Patent Application Publication
(10) Pub. No.: US 2013/0259181 A1
(43) Pub. Date: Oct. 3, 2013

(54) Device for Generating a High Temperature Gradient in a Nuclear Fuel Sample

(71) Applicant: COMMISSARIAT A L'ENERGIE ATOMIQUE ET AUX ENERGIES ALTERNATIVES, (US)

(72) Inventors: Yves PONTILLON, Pierrevert (FR); Lionel DESGRANGES, Pertuis (FR); Eric HANUS, Manosque (FR); Olivier BREMOND, Rians (FR)

(73) Assignee: COMMISSARIAT A L'ENERGIE ATOMIQUE ET AUX ENERGIES ALTERNATIVES, Paris (FR)

(21) Appl. No.: 13/855,615

(22) Filed: Apr. 2, 2013

(30) Foreign Application Priority Data
Apr. 2, 2012 (FR) 12 53001

(51) Int. Cl. G21C 17/112

(52) U.S. Cl. CPC G21C 17/112
USPC 376/247

(57) ABSTRACT

An assembly comprising a sample and a device for generating a high temperature gradient in said sample, comprises: a chamber inside which said sample is placed; a resistor passing through said sample; first induction means at the periphery of the chamber to create an electromagnetic field; second induction means connected to said resistor and capable of picking up said electromagnetic field so as to create an induced current circulating in said resistor.

### CROSS-REFERENCE TO RELATED APPLICATION

This application claims priority to foreign French patent application No. FR 1253001, filed on Apr. 2, 2012, the disclosure of which is incorporated by reference in its entirety.

### FIELD OF THE INVENTION

The field of the invention is that of the heating devices comprising the controlled generation of heat gradient within a sample that is of particular interest in controlling and characterizing the behaviour of nuclear fuels under a heat gradient and which can be used in a laboratory of high nuclear activity.

### BACKGROUND

In this field, it has already been proposed by the Applicant to produce a heat gradient by an electric heating at the core of the ceramics and the circulation of water outside the cladding of the ceramics. However, this device has not been used on irradiated nuclear fuels.

Also known, from the patent U.S. Pat. No. 4,643,866, are means making it possible to provide a heat gradient ensured by a core heating of the ceramics using microwaves and the circulation of water outside the cladding of the ceramics.

The publication Nuclear Engineering and Design 26, (1974) 423-431, J. F. Whatham also describes an electric heating of the ceramics with cooling by pressurized water circulation.

Currently, the few trials of heat gradient presented, carried out on fuel rods, have been conducted on non-irradiated materials in an inert atmosphere. Now, the effects of the irradiation rapidly affect (in less than one cycle of a pressurized water reactor, PWR) the mechanical and chemical properties of the pellet and of the cladding, as well as their interface, significantly modifying the behaviour of the nuclear fuel.

Now, in the context of the management of fuels such as MOX with high plutonium content with degraded isotopic vector, the MOX (mixed oxides) fuel containing plutonium dioxide PuO₂ and uranium dioxide UO₂, manufactured from approximately 7% plutonium and 93% depleted uranium, the knowledge of the transfer effects of the fission products, notably gaseous, within the fuel and of the release conditions needs to be improved.

More specifically, in the current nuclear reactors, operated by EDF, the fuels take the form of UO₂ or (U,Pu)O₂ pellets stacked in a cladding of zirconium alloy. During the irradiation, there occurs, notably because of thermomechanical phenomena, an interaction between the pellets and the cladding (also called pellet-cladding interaction: PCI). Now, in certain accidental transient power conditions, the fuel may undergo a significant and rapid temperature increment relative to its normal situation. This heat transient provokes an increase in the stress of the pellet on the cladding and can cause it to break. Since the cladding is the first containment barrier against the fission products, it is essential to guarantee its integrity and therefore to best know these PCI phenomena.

There is therefore a particular interest in carrying out analytical trials capable of simulating the heat gradient undergone by the nuclear fuel during different power “transients” and more specifically to have a device for characterizing the behaviour of the nuclear fuels under a heat gradient which can be used in a high activity laboratory. Such analytical trials may make it possible to select materials in order to obtain a so-called remedial fuel that does not cause the first containment barrier to rupture in certain accidental power transient conditions.

### SUMMARY OF THE INVENTION

In this context, the Applicant has developed an experimental device named DURANCE (A device simulating the behaviour of fuels under a heat gradient). This DURANCE device comprises a heat gradient within the sample, ensured by a heating mandrel inserted at the core and a system of insulating material cooled by an ancillary device. The amplitude of the heat gradient between the core of the sample and the outer face of the cladding is, consequently, driven by the core temperature level and the nature, the thickness and the external temperature of the insulators.

In this context, the Applicant has sought to develop a device that makes it possible to reproduce and control the amplitude of the heat gradient undergone by the nuclear fuel during certain accidental situations and to do so using an installation of reduced size that can easily be adapted to the heat treatment ovens used by the laboratory in a high activity cell and by dispensing with any circulation of water (pressurized or not) in contact with the fuel element, the heating being ensured by induction. The development of an induction heating system for two to three fuel pellets ensuring a heat flux from inside to outside of the latter makes it possible to represent the temperature profile observed in a reactor. It is intended to make it possible to move forward on the issue associated with the risk of rupture of the cladding by pellet-cladding interaction/stress corrosion (PCI/SC) of the fuel rods in an accidental situation, the limited number of full power ramp tests not making it possible to individually test all of the parameters and fuel grades or to access, in a decoupled manner, the physical phenomena. Now, certain key mechanisms involved in the phenomenon of interaction of the pellet with the cladding are as yet little known and constitute a limiting factor in understanding the ramps and the representativeness of the digital models simulating PCI.

One of the important objectives of the device proposed in the present invention is therefore to reproduce and control the amplitude of the heat gradient undergone by a nuclear fuel during certain accidental situations and to do so using an installation of reduced size that can easily be adapted to the heat treatment ovens used by a laboratory in the high activity cell and by dispensing with any circulation of water (pressurized or not) in contact with the fuel element, the heating being ensured by induction.

The device of the present invention notably constitutes a solution that may make it possible to raise the fuel to a central temperature that can be as high as 2000° C., even more, and stabilize the cladding temperature in the region of 350° C.+/−50° C. on typically three fuel pellets.

More specifically, the subject of the present invention is an assembly comprising a sample and a device for generating a high temperature gradient in said sample, characterized in that it comprises:
a chamber inside which said sample is placed;
a resistor passing through said sample;
first induction means at the periphery of the chamber to create an electromagnetic field;
second induction means connected to said resistor and capable of picking up said electromagnetic field so as to create an induced current circulating in said resistor.

According to a variant of the invention, the first induction means comprise at least one first coil.

According to a variant of the invention, the second means comprise at least one second coil.

According to a variant of the invention, the chamber is a quartz tube.

According to a variant of the invention, the sample comprises a ceramic pellet that can be of Al₂O₃, or of ZrO₂ or a nuclear fuel pellet that can be of UO₂ or of MOX.

According to a variant of the invention, the sample comprises a metallic cladding at the periphery of said pellet and in direct contact with said pellet.

According to a variant of the invention, it also comprises a heat insulating element at the periphery of said sample.

According to a variant of the invention, the sample comprises a ceramic pellet, the insulator being of alumina.

According to a variant of the invention, the sample comprises a ceramic pellet, the insulator being of hafnium.

According to a variant of the invention, the sample comprises a fuel that can be of UO₂, the insulator being able to be of UO₂ or of hafnium.

According to a variant of the invention, the resistor is of refractory metal that can be of tungsten or of molybdenum.

According to a variant of the invention, said assembly also comprises an exchanger, said second induction means being situated at the periphery of said exchanger.

According to a variant of the invention, the exchanger comprises a fluid circulation system.

According to a variant of the invention, said assembly also comprises means for measuring the temperature of said sample.

According to a variant of the invention, the temperature measuring means comprise a thermocouple.

Another subject of the invention is an assembly according to the invention comprising a pyrometer.

Another subject of the invention is an assembly according to the invention comprising an infrared camera.

### BRIEF DESCRIPTION OF THE DRAWINGS

The invention will be better understood, and other advantages will become apparent, on reading the following description, given as a nonlimiting example and from the appended figures in which:

FIG. 1 illustrates a heating device or MERARG oven developed by the applicant;

FIG. 2 illustrates a device according to the invention;

FIGS. 3a and 3b illustrate geometrical models of the assembly; fuel pellet surrounded by insulator, heated notably by a metal mandrel in a device of the invention;

FIG. 4 illustrates the finite element heat model for a fuel pellet surrounded by insulator;

FIG. 5 illustrates the trend of the temperature as a function of radial coordinates for different insulators and a ceramic pellet of alumina;

FIG. 6 illustrates the trend of the temperature as a function of radial coordinates for different insulators and a ceramic pellet of zirconium;

FIG. 7 illustrates the trend of the temperature as a function of radial coordinates for different insulators and a ceramic pellet of UO_{2;}

FIG. 8 illustrates an exploded view of different elements included in an exemplary device of the invention;

FIG. 9 illustrates an exemplary cycle of temperatures applied to the central resistor in a device of the invention.

### DETAILED DESCRIPTION

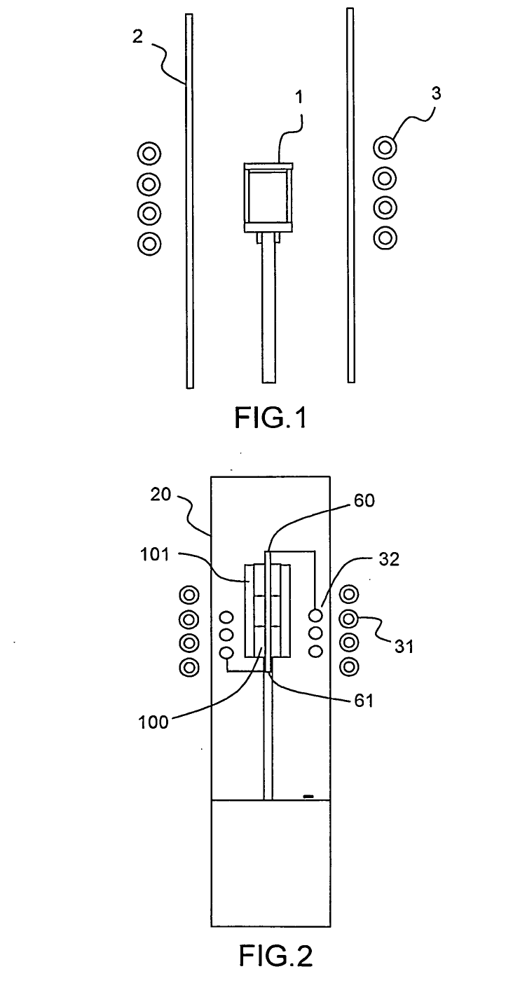

The applicant has developed an MERARG oven such as that illustrated in FIG. 1 that makes it possible to heat a metal crucible by inductive coupling. So-called induction turns 3, passed through by a high-frequency current, make it possible to create induced currents in the metal crucible 1. Through the Joule effect, these induced currents thus heat the walls of the crucible, which in turn raises a sample to high temperature isothermally, the crucible itself being placed in a tube 2.

However, the use of the induction heating cannot be directly transcribed to the DURANCE device. In practice, using the resistor at the centre of the pellets as susceptor (corresponding to the piece to be heated, also called susceptor and, generally, the susceptor must be an electrical conductor) with respect to the induction cannot be considered because the cladding of zirconium alloy (metal element) situated between the centre of the pellets and the turn, would be subject to the coupling. The cladding would therefore be heated in the same way as the crucible in MERARG.

In order to be able to make use of the electromagnetic field created by first induction means that can be an induction turn to heat the central resistive system, the solution proposed in the present invention adapts the principle of an electrical transformer.

The electromagnetic field is thus according to the present invention picked up by first induction means that can be a so-called transformation turn (coil). This turn then creates a so-called induced current which circulates in the resistor. This turn is placed inside the quartz tube and centred at the level of the induction turn.

This device indeed makes it possible to keep the same power input system. It also makes it possible to retain the quartz tube which guarantees the seal-tightness of the oven and which, by its physico-chemical properties, does not interact on the coupling phenomenon.

FIG. 2 thus illustrates a device of the invention comprising, in a chamber 20, a resistor 60, a first induction turn 31 and a second so-called transformation turn 32. The sample to be heated 100 is surrounded by a cladding which is not represented and by an insulator 101 and is passed through by the resistor 60 at its centre. A thermocouple 61 is also provided for the temperature measurement.

The device of the present invention thus makes it possible to heat up, by inductive coupling, a metallic element, and then, by resistive heating of the resistor 60, to heat up the interior of the pellets. This set up makes it possible to keep the same power input system. It also makes it possible to retain, for example, a quartz tube which guarantees the seal-tightness of the oven and which, by its physico-chemical properties, does not interact on the coupling phenomenon.

For this principle to supply a more uniform heating within the stack of fuel pellets, the coupling turns can advantageously be doubled and two metallic elements on either side be heated by induction.

Thermal Validation of the Resistive Heating System

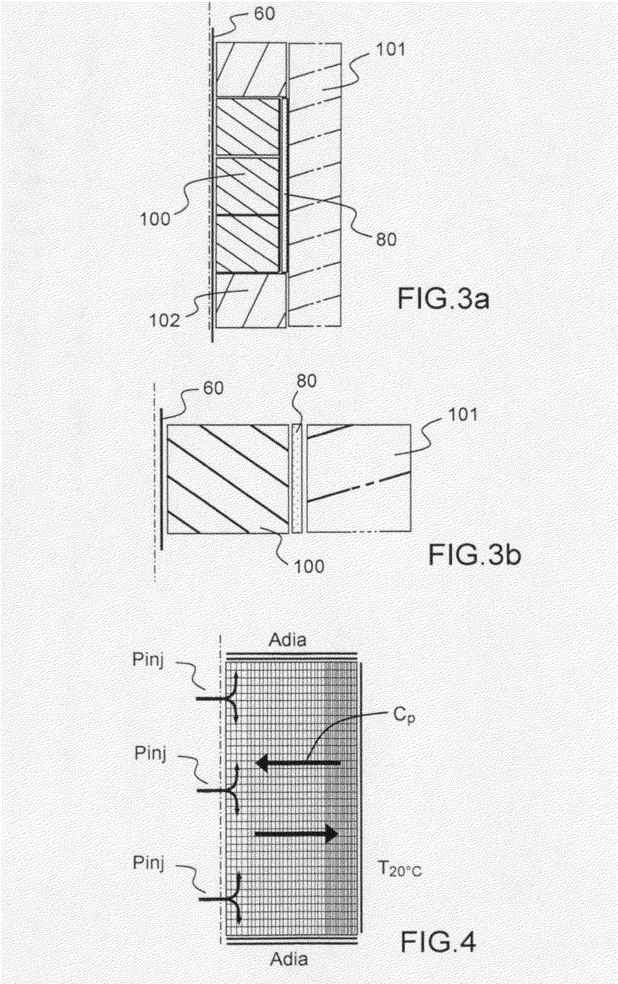

Generally, the DURANCE device seeks to apply a known and predetermined radial heat gradient within an irradiated nuclear ceramic. In order to validate the concept envisaged, the Applicant has modelled, under Cast3m, the thermal behaviour of the device of the invention. This modelling has made it possible, initially, and through a parametric study that is as simple as possible, to confirm the presence of a radial gradient within the pellets and to specify the nature and geometry of the insulators to obtain the desired heat gradient. This analysis details the assumptions made to obtain a simplified DURANCE model (definition of the geometrical model, definition of the heat model, etc.). The results obtained were compared to the objectives desired to conclude on the validity of the concept. It was decided to model the DURANCE device axisymmetrically initially on a stack of three pellets and then, to further simplify the model, on only the central pellet by disregarding the edge effects of the two end pellets. It is then considered that there is no heat exchange on the bottom and top faces (adiabatic condition). FIGS. 3a and 3b illustrate the different elements represented in cross section from the central resistor 60: it is more specifically from the centre of the sample to the exterior of the pellet: fuel 100 placed between two chocks 102, cladding 80, insulator 101. It is also considered that the gaps are nonexistent between the pellets and the cladding but also between the cladding and the insulator. Since the contact is considered to be perfect between these elements just one heat transfer mode is considered: conduction.

The cooling circuit is modelled by a temperature set at 20° C. corresponding to the temperature of the water circulating in the exchanger as illustrated in FIG. 4 which highlights, according to the heat model, the volume power injected Pᵢₙⱼ and the almost perfect conduction Cₚ between the different materials (pellet, cladding, insulator), between two adiabatics A_{dia}.

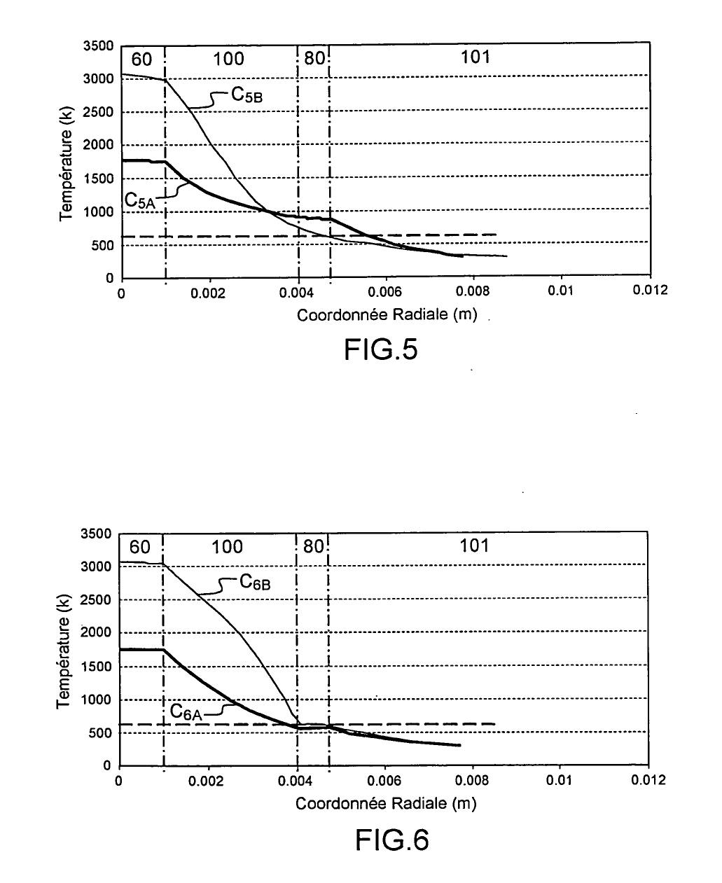

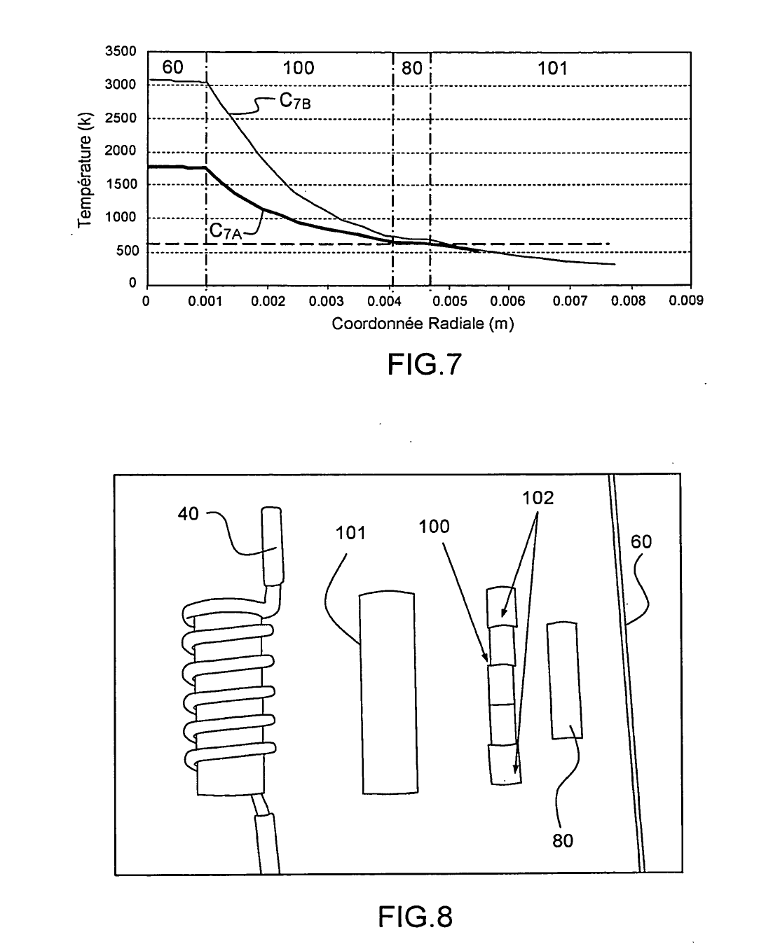

After having entered the thermal properties of the materials studied into the models considered, the thermal computations highlight the results detailed in FIG. 5, FIG. 6 and FIG. 7, respectively for the following materials: Al₂O₃, ZrO₂ and UO₂ as fuels, and do so according to the different natures and thickness of the insulator. More specifically:
the curve C_{5A} relates to a hafnium insulator 3 mm thick, the curve C_{5B} relates to a 5 mm alumina insulator, for an alumina fuel;
the curve C_{6A} relates to a zirconium insulator 3 mm thick, the curves C_{6B} relates to a 5 mm alumina insulator, for a zirconium fuel;
the curve C_{7A} relates to a hafnium insulator of 3 mm, the curve C_{7B} relates to a 5 mm UO₂ insulator, for a UO₂ fuel.

These three figures show directly that it is possible, according to the type of sample (Al₂O₃, ZrO₂ and UO₂) serving as fuel, to propose an insulator system that makes it possible to reach the desired cladding temperature, regardless of the core thermal loading.

In practice, for one simulating fuel of alumina type, the modelling shows that, to obtain a temperature at the outer wall of the cladding of 350° C., the insulator to be used is dense alumina of 4 to 5 mm thick. The thickness of this insulator is to be determined according to the temperatures at the centre of the pellets. For one simulating fuel of zirconium type, the choice of the insulator is dense hafnium between 3 and 5 mm thick depending on the pellet-centre temperatures targeted. For fuel of the virgin UO₂ type, according to the temperatures injected at the core of the sample, the modelling reveals the use of an insulator either of UO₂ or of hafnium between 3 and 5 mm thick depending on the central temperature, and does so for a cladding temperature of 350° C.

From this heat modelling which makes it possible to validate the obtaining of a heat gradient and an adequate a priori heating principle, the Applicant has produced a prototype in order to verify the general principle and the correct operation, notably the resistive heating and the obtaining of a heat gradient through the intermediary of the different insulators and the use of a cooling system.

To make it possible to produce this prototype, various elements were required:
a resistor making it possible to reach the desired temperatures without excessive deformations thereof;
pierced pellets simulating the fuel;
a cladding of zircaloy4 (zirconium) three pellets high and with end chocks;
a set of insulators;
two turns, one for transformation to allow for the circulation of the induced currents in the resistor, one induction turn;
a heat exchanger in order to block the temperature outside the insulator at the water circulation temperature (or 20° C.).

These elements are presented in FIG. 8: the central resistor made of tungsten 60, the cladding 80, the three fuel pellets 100 inserted between two chocks 102, the insulator 101 and a water exchanger 40, these different elements are interleaved with one another then forming the complete system making it possible, using turns, to heat up the fuel pellets while cooling the cladding through the cooling circuit. The whole is incorporated in the transformation turn.

The duly constructed assembly can be integrated in a quartz tube that constitutes an advance on the MERARG II oven. The induction turn then couples on the transformation turn, the latter is short-circuited by the tungsten resistor, passing through the chocks and the fuel pellets. The transformation turn, the induction turn and the exchanger are all water-cooled.

A thermocouple is mounted in contact with the resistor to observe its behaviour when the device is powered up.

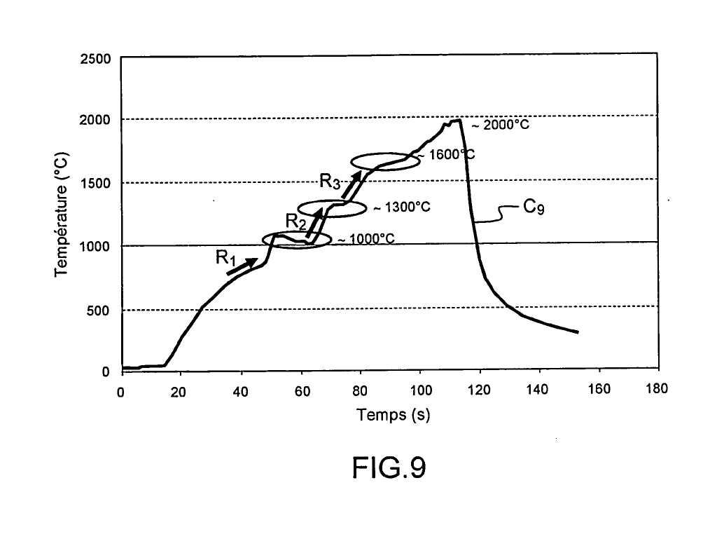

FIG. 9 illustrates the temperature cycles applied to the resistor. Three different ramps were applied and four temperature plateaus (1000° C., 1300° C., 1600° C. and 2000° C.) were maintained between the ramps R₁, R₂ and R₃, the curve C₉ relating to the temperature of the susceptor. The temperature of the resistor is deliberately limited to a temperature of 2000° C. over a very short time period.

These measurements validate the heating principle proposed in the present invention, allowing for more or less rapid temperature ramps, with temperature levels of the required ranges.

1. An assembly comprising a sample and a device for generating a high temperature gradient in said sample, comprising:
a chamber inside which said sample is placed;
a resistor passing through said sample;
first induction means at the periphery of the chamber to create an electromagnetic field; and
second induction means connected to said resistor and capable of picking up said electromagnetic field so as to create an induced current circulating in said resistor.

2. The assembly according to claim 1, wherein the first induction means comprise at least one first coil.

3. The assembly according to claim 1, wherein the second means comprise at least one second coil.

4. The assembly according to claim 1, wherein the chamber is a quartz tube.

5. The assembly according to claim 1, wherein the sample comprises a ceramic pellet of Al₂O₃, or of ZrO₂ or a nuclear fuel pellet of UO₂ or of MOX.

6. The assembly according to claim 5, wherein the sample comprises a metal cladding at the periphery of said pellet and in direct contact with said pellet.

7. The assembly according to claim 1, further comprising a heat insulating element at the periphery of said sample.

8. The assembly according to claim 7, wherein the sample comprises a ceramic pellet, the insulator being of alumina.

9. The assembly according to claim 7, wherein the sample comprises a ceramic pellet, the insulator being of hafnium.

10. The assembly according to claim 7, wherein the sample comprises a fuel of UO₂, the insulator being of UO₂ or hafnium.

11. The assembly according to claim 1, wherein the resistor is of refractory metal that can be of tungsten or molybdenum.

12. The assembly according to claim 1, further comprising an exchanger, said second induction means being situated at the periphery of said exchanger.

13. The assembly according to claim 12, wherein the exchanger comprises a fluid circulation system.

14. The assembly according to claim 1, further comprising means for measuring the temperature of said sample.

15. The assembly according to claim 14, wherein the temperature measuring means comprise a thermocouple.

16. The assembly according to claim 1, further comprising a pyrometer.

17. The assembly according to claim 1, further comprising an infrared camera.
